(19) United States
(12) Patent Application Publication
(10) Pub. No.: US 2024/0359647 A1
(43) Pub. Date: Oct. 31, 2024

(54) PENETRATION MEMBER MOUNTING STRUCTURE

(71) Applicant: YAZAKI CORPORATION, Tokyo (JP)

(72) Inventors: Hideaki Kikuchi, Susono-shi (JP); Hiroyuki Ogura, Susono-shi (JP)

(21) Appl. No.: 18/633,514

(22) Filed: Apr. 12, 2024

(30) Foreign Application Priority Data
Apr. 28, 2023 (JP) 2023-075008

(51) Int. Cl. B60R 16/02; B60R 13/02; H02G 3/22

(52) U.S. Cl. CPC B60R 16/0222; B60R 13/02; H02G 3/22

(57) ABSTRACT

In a penetration member mounting structure, to be mounted to penetrate a panel partitioning an interior of a vehicle body, a cutout is provided in an outer edge portion of the panel or a mounting portion of the vehicle body that the outer edge portion of the panel overlaps and on which the panel is mounted, and the penetration member is inserted into the cutout and mounted by being sandwiched between the vehicle body and the panel.

### CROSS-REFERENCE TO RELATED APPLICATION(S)

This application is based upon and claims the benefit of priority from prior Japanese patent application No. 2023-075008 filed on Apr. 28, 2023, the entire contents of which are incorporated herein by reference.

### BACKGROUND

### 1. Field of the Invention

The present disclosure relates to a penetration member mounting structure.

### 2. Description of the Related Art

An interior of a vehicle body may be partitioned by a panel. In the related art, it has been proposed to provide a through hole in a panel, insert a penetration member such as a wire harness, an electric junction box, and a connector into the through hole to mount the penetration member (JP2001-69640A, JP2002-2414A and JPH07-29638A).

According to the related art described above, there is a problem in that work for inserting the penetration member (the wire harness, the electric junction box, and the connector) into the through hole provided in the panel is necessary, and mounting work of the penetration member needs time.

### SUMMARY

The present disclosure has been made in view of the above circumstances, and an object thereof is to provide a penetration member mounting structure capable of reducing mounting work of a penetration member.

According to an aspect of the present disclosure, there is provided a penetration member mounting structure to be mounted to penetrate a panel partitioning an interior of a vehicle body, where a cutout is provided in an outer edge portion of the panel or a mounting portion of the vehicle body that the outer edge portion of the panel overlaps and on which the panel is mounted, and the penetration member is inserted into the cutout and mounted by being sandwiched between the vehicle body and the panel.

According to the present disclosure, it is possible to provide the penetration member mounting structure capable of reducing mounting work of the penetration member.

The present disclosure has been briefly described above. Further, details of the present disclosure can be clarified by reading modes (hereinafter, referred to as “embodiments”) for carrying out the disclosure described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a front view showing a mounting structure of a wire harness as a penetration member according to a first embodiment of the present disclosure;

FIG. 2 is an exploded view of the wire harness mounting structure shown in FIG. 1;

FIG. 3 is a cross-sectional view taken along a line A-A of FIG. 1;

FIG. 4 is a front view showing a mounting structure of an electric junction box as a penetration member according to a second embodiment of the present disclosure;

FIG. 5 is a cross-sectional view taken along a line B-B in FIG. 4;

FIG. 6 is a front view showing a mounting structure of a relay connector as a penetration member according to a third embodiment of the present disclosure;

FIG. 7 is a cross-sectional view taken along a line C-C of FIG. 6;

FIG. 8 is a front view showing a mounting structure of a wire harness as a penetration member according to a fourth embodiment of the present disclosure; and

FIG. 9 is an exploded view of the wire harness mounting structure shown in FIG. 8.

### DETAILED DESCRIPTION OF THE INVENTION

Specific embodiments of the present disclosure will be described below with reference to the drawings.

### First Embodiment

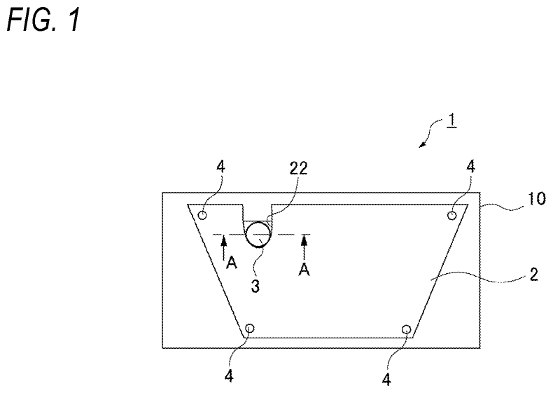

A mounting structure of a wire harness as a penetration member of a first embodiment will be described with reference to FIGS. 1 to 3. A wire harness mounting structure 1 shown in FIGS. 1 to 3 is a structure for mounting the wire harness 3 on a vehicle body 10 made of metal so as to make the wire harness 3 penetrate a panel 2 that separates a vehicle interior and a front compartment provided in front of the vehicle interior in the vehicle body 10.

Next, the vehicle body 10 on which the above-described panel 2 is mounted will be described. The vehicle body 10 on which the panel 2 of the present embodiment is mounted is formed by casting with a large mold.

The vehicle body 10 formed by casting with the large mold has high strength. Therefore, a partition wall between the vehicle interior and the front compartment does not need to have strength enough to maintain a shape of the vehicle body. Accordingly, the vehicle body 10 and the partition wall do not need to be integrally formed, and a separate partition wall can be adopted.

In addition, in the case of an electric automobile on which no engine is mounted, there is no internal combustion engine, a high temperature is hardly generated, and noise is small. For this reason, not only metal but also a resin can be adopted as the partition wall in the vehicle body 10.

For the reasons described above, in the present embodiment, the wire harness mounting structure 1 that is mounted on the vehicle body 10, which is formed by casting, of the electric automobile on which no engine is mounted and that adopts the resin panel 2 as the partition wall is exemplified.

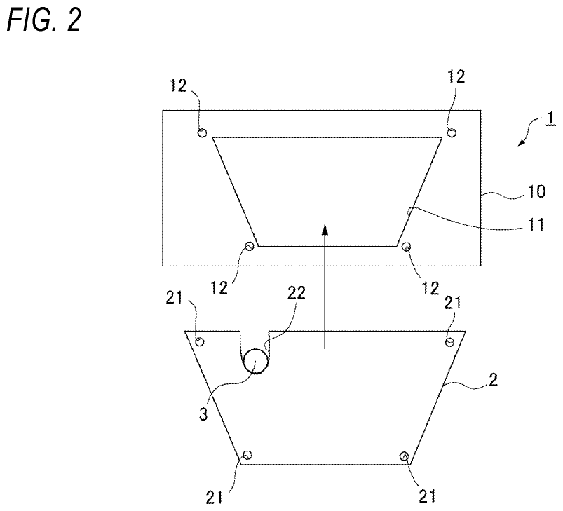

A vehicle interior in which a driver's seat, a front passenger's seat, and a rear seat are disposed, and a front compartment provided in front of the vehicle interior are formed in the vehicle body 10. As shown in FIG. 2, in the vehicle body 10, there is no partition wall between the vehicle interior and the front compartment, and an opening 11 is provided. The resin panel 2 is formed in a shape that closes the opening 11 between the vehicle interior and the front compartment. A plurality of bolt through holes 12 (FIG. 2) through which bolts 4 (FIG. 1) for mounting the resin panel 2 are passed are provided in an inner edge portion (mounting portion) of the opening 11 in the vehicle body 10.

The resin panel 2 is provided with bolt through holes 21 (FIG. 2) through which bolts 4 (FIG. 1) for mounting the resin panel 2 on the vehicle body 10 are passed. A plurality of bolt through holes 21 are provided along an outer edge portion of the resin panel 2.

In the present embodiment, a cutout 22 is provided in the outer edge portion of the resin panel 2. Then, as shown in FIG. 1, the wire harness 3 is inserted into the cutout 22 and mounted by being sandwiched between the vehicle body 10 and the resin panel 2. In the present embodiment, the cutout 22 is provided by cutting out an upper outer edge portion of the resin panel 2 downward. The lower end of the cutout 22 is provided in a curved shape along a circular outer periphery of the wire harness 3. An upper portion of the cutout 22 is opened, and the wire harness 3 can be inserted into the cutout 22 from the upper opening.

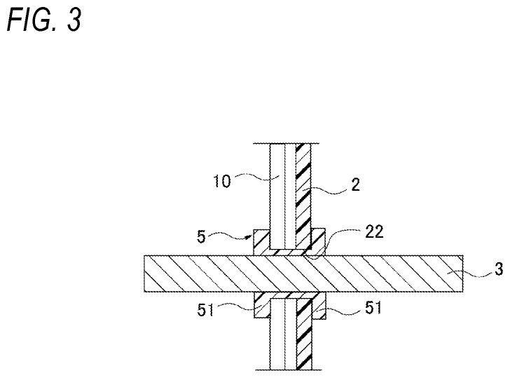

In the wire harness 3, a plurality of electric wires are bundled into one wire by tape winding or the like, and the wire harness 3 is routed from the vehicle interior to the front compartment. As shown in FIG. 3, a cylindrical grommet 5 formed of an elastic member such as rubber is externally fitted onto the wire harness 3. By inserting a portion of the grommet 5 that externally fits onto the wire harness 3 into the cutout 22, a gap between the wire harness 3 and the vehicle body 10 and the resin panel 2 can be closed by the grommet 5, thereby achieving waterproofing and soundproofing.

In the present embodiment, flange portions 51 protruding outward from both ends (both ends in a left-right direction in FIG. 3) in a penetration direction of the wire harness 3 are provided in the grommet 5, and the flange portions 51 overlap the resin panel 2 and the vehicle body 10, respectively.

Next, a procedure for mounting the wire harness 3 and resin panel 2 described above on the vehicle body 10 will be described. First, the portion of the grommet 5 that externally fits onto the wire harness 3 is inserted into the cutout 22 of the resin panel 2. At this time, the wire harness 3 is inserted from the upper opening of the cutout 22. In a state where the wire harness 3 is inserted into the cutout 22, the outer edge portion of the resin panel 2 overlaps the inner edge portion of the opening 11 provided in the vehicle body 10, and the bolt through hole 12 provided in the vehicle body 10 overlaps the bolt through hole 21 provided in the resin panel 2. In the present embodiment, the outer edge portion of the resin panel 2 overlaps the inner edge portion of the vehicle body 10 from a vehicle interior side. Then, the bolts 4 are passed through the bolt through holes 21 and 12 provided in the resin panel 2 and the vehicle body 10, and are fastened using nuts (not shown). Accordingly, the wire harness 3 is mounted by being sandwiched between the resin panel 2 and the vehicle body 10.

According to the embodiment described above, it is not necessary to move the wire harness 3 in the penetration direction to make the wire harness 3 penetrate the through hole provided in the resin panel 2, and mounting work of the wire harness 3 can be reduced.

Further, in the case of the related art in which the wire harness 3 is inserted into the through hole, if an outer diameter of the grommet 5 is too large, it is difficult to make the wire harness 3 penetrate the through hole, and thus the outer diameter of the grommet 5 is greatly limited. According to the present embodiment, since it is not necessary to allow the wire harness 3 to penetrate the through hole, the limitation of the outer diameter of the grommet 5 can be relaxed as compared with the related art, and a degree of freedom in design of the grommet 5 is improved.

### Second Embodiment

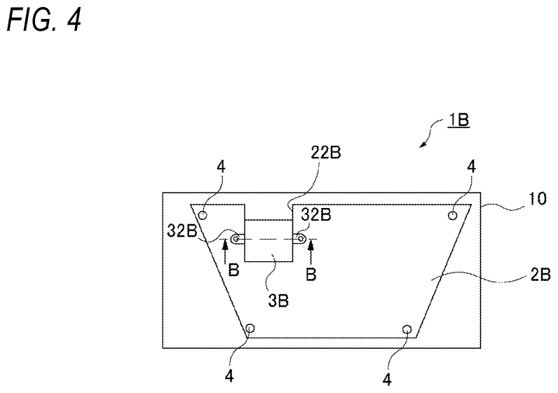

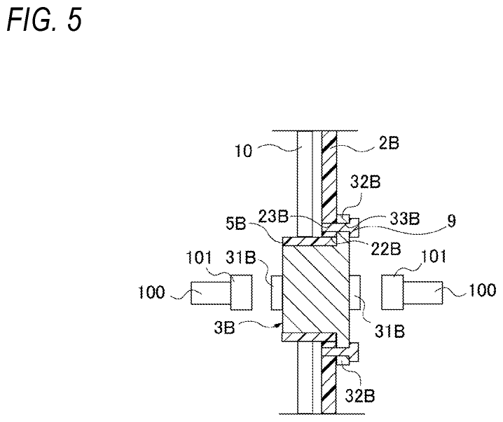

Next, a mounting structure of an electric junction box 3B as a penetration member of a second embodiment will be described with reference to FIGS. 4 and 5. In FIGS. 4 and 5, the same reference signs are given to the same parts as those shown in FIGS. 1 to 3 described in the first embodiment described above, and detailed description thereof will be omitted. A difference between the first embodiment and the second embodiment is that the electric junction box 3B is adopted instead of the wire harness 3 as the penetration member. The electric junction box mounting structure 1B shown in FIGS. 4 and 5 is a structure for mounting the electric junction box 3B on the vehicle body 10 so as to penetrate a resin panel 2B that separates a vehicle interior and a front compartment provided in front of the vehicle interior.

Since the vehicle body 10 is similar to that of the first embodiment, detailed description thereof is omitted here.

A difference between the resin panel 2 of the first embodiment and the resin panel 2B of the second embodiment is the shape of a cutout 22B and the fact that a bolt through hole 23B is provided in an edge portion of the cutout 22B.

In the present embodiment, the cutout 22B is provided in an outer edge portion of the resin panel 2B. Then, as shown in FIG. 4, the electric junction box 3B is inserted into the cutout 22B and mounted by being sandwiched between the vehicle body 10 and the resin panel 2B. The cutout 22B is provided by cutting out an outer edge portion of an upper portion of the resin panel 2B downward. The cutout 22B is provided in a rectangular shape along an outer diameter of the electric junction box. The upper portion of the cutout 22B is opened, and the electric junction box 3B can be inserted into the cutout 22B from the upper opening.

The electric junction box 3B is a well-known electric junction box in which electric components such as fuses are accommodated in a resin case. In the present embodiment, the electric junction box 3B has a resin case formed in a cubic shape. In the present embodiment, as shown in FIG. 5, the electric junction box 3B is provided with connector portions 31B on surfaces on a vehicle interior side and a front compartment side, respectively. The connector portion 31B is connected to a connector 101 provided at a terminal of a wire harness 100. Accordingly, both an electronic device disposed in the vehicle interior and an electronic device disposed in the front compartment can be connected to the electric junction box 3B via the connectors 101.

In the present embodiment, the electric junction box 3B is provided with flange portions 32B protruding outward from one end side in a penetration direction. As shown in FIG. 4, the flange portion 32B overlaps the edge portion of the cutout 22B of the resin panel 2B. As shown in FIG. 5, the flange portion 32B is provided with a bolt through hole 33B through which a bolt 9 passes. The bolt through hole 23B through which the bolt 9 passes is also provided in the edge portion of the cutout 22B of the resin panel 2B. When the electric junction box 3B is inserted into the cutout 22B, the bolt through hole 33B of the flange portion 32B and the bolt through hole 23B of the resin panel 2B are overlapped. After the bolt 9 is passed through the bolt through holes 33B and 23B, the electric junction box 3B can be fixed to the resin panel 2B by fastening using nuts (not shown).

A rectangular cylindrical grommet 5B formed of an elastic member such as rubber is externally fitted onto the electric junction box 3B. By closing a gap between the electric junction box 3B and the vehicle body 10, and the resin panel 2B with the grommet 5B, waterproofing and soundproofing can be achieved.

Next, a procedure for mounting the electric junction box 3B and the resin panel 2B described above on the vehicle body 10 will be described. First, the electric junction box 3B onto which the grommet 5B is externally fitted is inserted into the cutout 22B of the resin panel 2B. At this time, the electric junction box 3B is inserted from the upper opening of the cutout 22B. Thereafter, the electric junction box 3B is fixed to the resin panel 2B using the bolts 9. Next, similarly to the procedure of mounting the resin panel 2 of the first embodiment on the vehicle body 10, the resin panel 2B to which the electric junction box 3B is fixed is mounted on the vehicle body 10.

According to the embodiment described above, similar to the first embodiment, mounting work of the electric junction box 3B can be reduced, and a degree of freedom in design of the grommet 5B is also improved.

### Third Embodiment

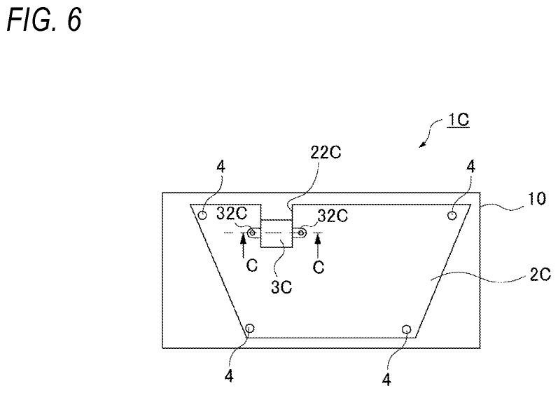

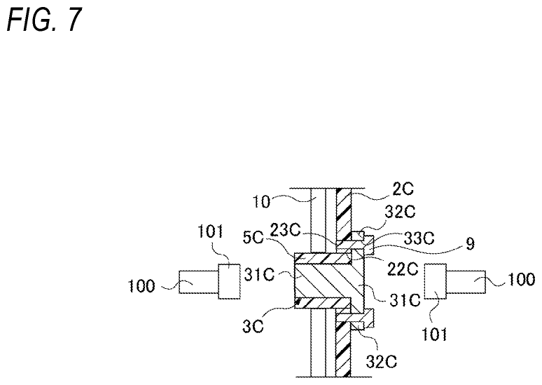

Next, a mounting structure of a relay connector 3C as a penetration member of a third embodiment will be described with reference to FIGS. 6 and 7. In FIGS. 6 and 7, the same reference signs are given to the same parts as those shown in FIGS. 1 to 5 described in the first and second embodiments described above, and detailed description thereof will be omitted. The third embodiment is different from the first and second embodiments in that the relay connector 3C (connector) is adopted instead of the wire harness 3 and the electric junction box 3B as the penetration member. A relay connector mounting structure 1C shown in FIGS. 6 and 7 is a structure for mounting the relay connector 3C on the vehicle body 10 so as to penetrate the resin panel 2C that separates a vehicle interior and a front compartment provided in front of the vehicle interior.

Since the vehicle body 10 is similar to that of the first embodiment, detailed description thereof is omitted here.

The resin panel 2B of the second embodiment is different from the resin panel 2C of the third embodiment in a shape of a cutout 22C and in that a bolt through hole 23C is provided in an edge portion of the cutout 22C.

In the present embodiment, the cutout 22C is provided in an outer edge portion of the resin panel 2C. Then, as shown in FIG. 6, the relay connector 3C is inserted into the cutout 22C and mounted by being sandwiched between the vehicle body 10 and the resin panel 2C. The cutout 22C is provided by cutting out an outer edge portion of an upper portion of the resin panel 2C downward. The resin panel 2C is provided in a rectangular shape along an outer diameter of the relay connector 3C. An upper portion of the cutout 22C is opened, and the relay connector 3C can be inserted into the cutout 22C from the upper opening.

The relay connector 3C is a known relay connector in which a terminal fitting is accommodated in a housing having a rectangular cylindrical shape. In the present embodiment, as shown in FIG. 7, the relay connector 3C is provided with connector portions 31C on a vehicle interior side and a front compartment side, respectively. The connector portion 31C is connected to the connector 101 provided at a terminal of the wire harness 100. Accordingly, an electronic device disposed in the vehicle interior and an electronic device disposed in the front compartment can be connected via the relay connector 3C and the wire harness 100.

In the present embodiment, the relay connector 3C is provided with a flange portion 32C protruding outward from one end side in a penetration direction. As shown in FIG. 7, the flange portion 32C overlaps an edge portion of the cutout 22C of the resin panel 2C. As shown in FIG. 7, the flange portion 32C is provided with a bolt through hole 33C through which the bolt 9 passes. The bolt through hole 23C through which the bolt 9 passes is also provided in an edge portion of the cutout 22C of the resin panel 2C. When the relay connector 3C is inserted into the cutout 22C, the bolt through hole 33C of the flange portion 32C and the bolt through hole 23C of the resin panel 2C are overlapped. After the bolt 9 is passed through the bolt through holes 33C and 23C, the relay connector 3C can be fixed to the resin panel 2C by fastening using nuts (not shown).

A rectangular cylindrical grommet 5C formed of an elastic member such as rubber is externally fitted onto the relay connector 3C. By closing a gap between the relay connector 3C and the vehicle body 10 and the resin panel 2C with the grommet 5C, waterproofing and soundproofing can be achieved.

Since the mounting of the relay connector 3C on the resin panel 2C and the mounting of the resin panel 2C on the vehicle body 10 are similar to the mounting of the electric junction box 3B on the resin panel 2B and the mounting of the resin panel 2B on the vehicle body 10 of the second embodiment, detailed description thereof will be omitted here.

According to the embodiment described above, similar to the first embodiment, mounting work of the relay connector 3C can be reduced, and a degree of freedom in design of the grommet 5C is also improved.

### Fourth Embodiment

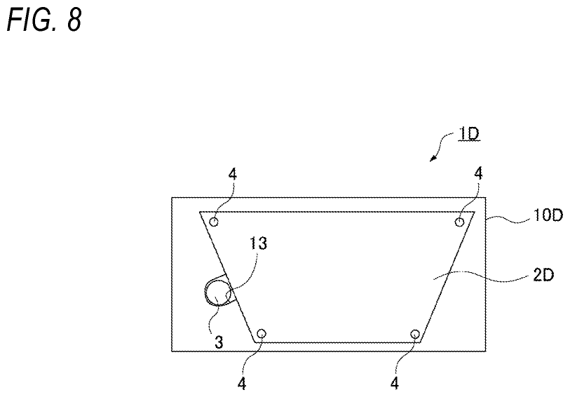

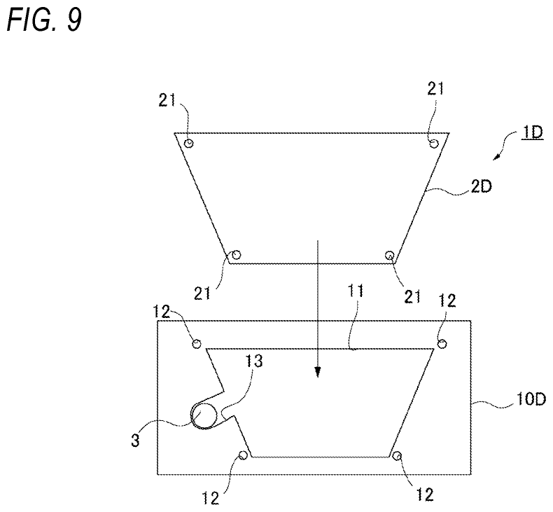

Next, a wire harness mounting structure 1D of a fourth embodiment will be described with reference to FIGS. 8 and 9. In FIGS. 8 and 9, the same reference signs are given to the same parts as those shown in FIGS. 1 to 3 described in the first embodiment described above, and detailed description thereof will be omitted.

A difference between the vehicle body 10 of the first embodiment and a vehicle body 10D of the fourth embodiment is that a cutout 13 into which the wire harness 3 is inserted is provided in an inner edge portion of the opening 11 of the vehicle body 10D of the fourth embodiment. The wire harness 3 is inserted into the cutout 13 and mounted by being sandwiched between the vehicle body 10D and a resin panel 2D. In the present embodiment, the cutout 13 is provided by cutting out from an inner edge portion on a left side of the vehicle body 10D toward lower left, and a right opening is provided. The wire harness 3 can be inserted into the cutout 13 from the right opening.

The resin panel 2D of the fourth embodiment is not provided with a cutout. Since the wire harness 3 is similar to that of the first embodiment, detailed description thereof is omitted here.

Next, a procedure for mounting the wire harness 3 and the resin panel 2D described above on the vehicle body 10D will be described. First, the portion of the grommet 5 that externally fits onto the wire harness 3 is inserted into the cutout 13 of the vehicle body 10D. At this time, the wire harness 3 is inserted from the right opening of the cutout 13. Next, the resin panel 2D is mounted on the vehicle body 10D. Accordingly, the wire harness 3 is mounted by being sandwiched between the resin panel 2D and the vehicle body 10D.

According to the embodiment described above, similar to the first embodiment, mounting work of the wire harness 3 can be reduced, and a degree of freedom in design of the grommet 5 is also improved.

The present disclosure is not limited to the embodiments described above and can be appropriately modified, improved and the like. In addition, materials, shapes, sizes, numbers, arrangement positions and the like of components in the embodiments described above are freely selected and are not limited as long as the present disclosure can be implemented.

According to the fourth embodiment described above, the wire harness 3 is a penetration member, but the present disclosure is not limited thereto. As in the second and third embodiments, the electric junction box 3B and the relay connector 3C may be inserted into the cutout 13 on a vehicle body 10D side. The electric junction box 3B and the relay connector 3C may be fastened to the vehicle body 10D by bolts.

For example, a material of the panel 2 that separates the vehicle interior and the front compartment is not limited to a resin, and may be metal or carbon.

According to the embodiments described above, the vehicle body 10 is formed by casting, but the vehicle body 10 is not limited to being formed by casting as long as the panel 2 can be adopted. For example, the vehicle body 10 may be formed by forging.

According to the embodiments described above, the vehicle body 10 to which the panel 2 is mounted is a vehicle body of an electric automobile, but the present disclosure is not limited thereto. The vehicle body 10 of an automobile on which an engine is mounted may be used.

According to the embodiments described above, the resin panel 2 separates the vehicle interior and the front compartment of the vehicle body 10, but the present disclosure is not limited thereto. The resin panel 2 may be any member as long as it partitions the interior of the vehicle body, and may be, for example, a member that separates the vehicle interior and a rear compartment.

According to the embodiments described above, the cutouts 22, 22B, 22C, and 13 are provided in any one of the vehicle bodies 10 and 10D and the resin panels 2, 2B to 2D. Both the vehicle bodies 10 and 10D and the resin panels 2 and 2B to 2D may be provided with cutouts.

According to the embodiments described above, a soundproof structure or a waterproof structure adopts the grommets 5, 5B, and 5C formed of elastic bodies, but the present disclosure is not limited thereto. The soundproof structure or the waterproof structure may be any structure as long as the gap between the wire harness 3, the electric junction box 3B, and the relay connector 3C (penetration member) and the vehicle bodies 10 and 10D and the resin panels 2 and 2B to 2D can be prevented, and may be formed of a non-elastic body. For example, the soundproof structure or the waterproof structure may be formed of a non-elastic body such as metal, a resin, or a nonwoven fabric.

Here, features of the above-described embodiments of the penetration member mounting structure according to the present disclosure will be briefly summarized and listed in the following [1] to [4].

[1] A penetration member mounting structure (1, 1B to 1D) to be mounted to penetrate a panel (2, 2B to 2D) partitioning an interior of a vehicle body (10, 10D), in which
a cutout (22, 22B, 22C, 13) is provided in an outer edge portion of the panel (2, 2B to 2D) or a mounting portion of the vehicle body (10, 10D) that the outer edge portion of the panel (2, 2B to 2D) overlaps and on which the panel is mounted, and
the penetration member (3, 3B, 3C) is inserted into the cutout (22, 22B, 22C, 13) and mounted by being sandwiched between the vehicle body (10, 10D) and the panel (2, 2B to 2D).

According to the configuration of the above [1], when the penetration member (3, 3B, 3C) is inserted from an opening of the cutout (22, 22B, 22C, 13) and the panel (2, 2B to 2D) is mounted on the vehicle body (10, 10D), the penetration member (3, 3B, 3C) inserted into the cutout (22, 22B, 22C, 13) is mounted by being sandwiched between the panel (2, 2B to 2D) and the vehicle body (10, 10D). Accordingly, it is not necessary to perform work of making the penetration member (3, 3B, 3C) penetrate the through hole provided in the panel (2, 2B to 2D), and mounting work of the penetration member (3, 3B, 3C) can be reduced.

[2] The penetration member mounting structure (1, 1B to 1D) according to the above [1], in which
the penetration member is at least one of an electric wire (3), an electric junction box (3B), and a connector (3C).

According to the configuration of the above [2], the mounting work of the electric wire (3), the electric junction box (3B), and the connector (3C) can be reduced.

[3] The penetration member mounting structure (1, 1B to 1D) according to the above [1], further includes:
at least one of a waterproof structure and a soundproof structure (5, 5B, 5C) configured to close a gap between the penetration member (3, 3B, 3C) and the vehicle body (10, 10D) and the panel (2, 2B to 2D).

According to the configuration of the above [3], since the penetration member (3, 3B, 3C) does not need to penetrate a through hole, at least one of the waterproof structure and the soundproof structure (5, 5B, 5C) can be easily achieved.

[4] The penetration member mounting structure (1, 1B to 1D) according to the above [1], in which
the panel (2, 2B to 2D) is a panel configured to separate a vehicle interior and a front compartment provided in front of the vehicle interior.

According to the configuration of the above [4], an electronic device disposed in a vehicle interior and an electronic device disposed in a front compartment can be connected.

1. A penetration member mounting structure, to be mounted to penetrate a panel partitioning an interior of a vehicle body, wherein:
a cutout is provided in an outer edge portion of the panel or a mounting portion of the vehicle body that the outer edge portion of the panel overlaps and on which the panel is mounted; and
the penetration member is inserted into the cutout and mounted by being sandwiched between the vehicle body and the panel.

2. The penetration member mounting structure according to claim 1, wherein
the penetration member is at least one of an electric wire, an electric junction box, and a connector.

3. The penetration member mounting structure according to claim 1, further comprising:
at least one of a waterproof structure and a soundproof structure configured to close a gap between the penetration member and the vehicle body and the panel.

4. The penetration member mounting structure according to claim 1, wherein
the panel is a panel configured to separate a vehicle interior and a front compartment provided in front of the vehicle interior.
